(19) United States
(12) Patent Application Publication
(10) Pub. No.: US 2003/0009676 A1
(43) Pub. Date: Jan. 9, 2003

(54) Peripheral device with secure driver

(76) Inventors: Terry L. Cole, Austin, TX (US); David W. Smith, Cedar Park, TX (US); Rodney Schmidt, Austin, TX (US); Geoffrey S. Strongin, Austin, TX (US); Brian C. Barnes, Round Rock, TX (US); Michael Barclay, Swallowcliffe (GB)

Correspondence Address: WILLIAMS MORGAN & AMERSON, 7676 HILLMONT, SUITE 250, HOUSTON, TX, 77040, US

(21) Appl. No.: 09/901,176

(22) Filed: Jul. 9, 2001

(51) Int. Cl. H04L 9/32

(52) U.S. Cl. 713/189

(57) ABSTRACT

A computer system includes a peripheral device and a processor complex coupled to the peripheral device. The processor complex is adapted to load a secure driver including program instructions for interfacing with the peripheral device. A method for protecting a software driver includes storing a secure driver in a computer system. The secure driver includes program instructions for interfacing with a peripheral device. The method further includes loading the secure driver; and interfacing with the peripheral device using the secure driver. The peripheral device may be a communications device, such as a software modem.

### BACKGROUND OF THE INVENTION

1. Field of the Invention

This invention relates generally to computer systems and, more particularly, to a peripheral device with a secure driver.

2. Description of the Related Art

In recent years cellular telephones have become increasingly popular. A cellular telephone is one example of what is referred to as a “mobile station” or “mobile terminal.” A mobile station can take on various forms other than a cellular telephone, including a computer (e.g., a notebook computer) with mobile communication capabilities.

Telecommunications services are provided between a cellular telecommunications network and a mobile station over an air interface, e.g., over radio frequencies. Typically, each subscriber having a mobile station is assigned a unique International Mobile Subscriber Identity (IMSI). At any moment, an active mobile station may be in communication over the air interface with one or more base stations. The base stations are, in turn, managed by base station controllers, also known as radio network controllers. A base station controller together with its base stations comprise a base station system. The base station controllers of a base station system are connected via control nodes to a core telecommunications network, such as the publicly switched telephone network (PSTN). One type of standardized mobile telecommunications scheme is the Global System for Mobile communications (GSM). GSM includes standards that specify functions and interfaces for various types of services. GSM systems may be used for transmitting both voice and data signals.

A particular base station may be shared among multiple mobile stations. Because the radio spectrum is a limited resource, the bandwidth is divided using combination of Time-Division and Frequency-Division Multiple Access (TDMA/FDMA). FDMA involves dividing the maximum frequency bandwidth (e.g., 25 MHz) into 124 carrier frequencies spaced 200 kHz apart. A particular base station may be assigned one or more carrier frequencies. Each carrier frequency is, in turn, divided into time slots. During an active session between the base station and the mobile station, the base station assigns the mobile unit a frequency, a power level, and a time slot for upstream transmissions from the mobile station to the base station. The base station also communicates a particular frequency and time slot for downstream transmissions from the base station destined for the mobile station.

The fundamental unit of time defined in GSM is referred to as a burst period, which lasts 15/26 ms (or approx. 0.577 ms). Eight burst periods are grouped into a TDMA frame (120/26 ms, or approx. 4.615 ms), which is the basic unit for the definition of logical channels. One physical channel is defined as one burst period per frame. Individual channels are defined by the number and position of their corresponding burst periods.

GSM frames, each frame having 8 burst periods, are grouped into superframes (e.g., groups of 51 frames) that include both traffic (i.e., voice or data signals) and control information. The control information is conveyed over common channels defined in the superframe structure. Common channels can be accessed both by idle mode and dedicated mode mobile stations. The common channels are used by idle mode mobile stations to exchange signaling information for changing to dedicated mode in response to incoming or outgoing calls. Mobile stations already in the dedicated mode monitor the surrounding base stations for handover and other information.

The common channels include:

a Broadcast Control Channel (BCCH) used to continually broadcasts information including the base station identity, frequency allocations, and frequency-hopping sequences;

a Frequency Correction Channel (FCCH) and Synchronization Channel (SCH) used to synchronize the mobile station to the time slot structure of a cell by defining the boundaries of burst periods, and the time slot numbering (i.e., every cell in a GSM network broadcasts exactly one FCCH and one SCH, which are, by definition, sent on time slot number 0 within a TDMA frame);

a Random Access Channel (RACH) used by the mobile station to request access to the network;

a Paging Channel (PCH) used to alert the mobile station of an incoming call; and

an Access Grant Channel (AGCH) used to allocate a Stand-alone Dedicated Control Channel (SDCCH) to a mobile station for signaling (i.e., to obtain a dedicated channel) following a request on the RACH.

For security reasons, GSM data is transmitted in an encrypted form. Because a wireless medium can be accessed by anyone, authentication is a significant element of a mobile network. Authentication involves both the mobile station and the base station. A Subscriber Identification Module (SIM) card is installed in each mobile station. Each subscriber is assigned a secret key. One copy of the secret key is stored in the SIM card, and another copy is stored in a protected database on the communications network that may be accessed by the base station. During an authentication event, the base station generates a random number that it sends to the mobile station. The mobile station uses a random number, in conjunction with the secret key and a ciphering algorithm (e.g., A3), to generate a signed response that is sent back to the base station. If the signed response sent by the mobile station matches the one calculated by network, the subscriber is authenticated. The base station encrypts data transmitted to the mobile station using the secret key. Similarly, the mobile station encrypts data it transmits to the base station using the secret key. After a transmission received by the mobile station is decrypted, various control information, including the assigned power level, frequency, and time slot for a particular mobile station may be determined by the mobile station.

Generally, communication systems are described in terms of layers. The first layer, responsible for the actual transmission of a data carrying signal across the transmission medium, is referred to as the physical layer (PHY). The physical layer groups digital data and generates a modulated waveform based on the data in accordance with the particular transmission scheme. In GSM, the physical layer generates the transmission waveform and transmits during the assigned transmit time slot of the mobile station. Similarly, the receiving portion of the physical layer identifies data destined for the mobile station during the assigned receipt time slot.

The second layer, referred to as a protocol layer, processes digital data received by the physical layer to identify information contained therein. For example, in a GSM system, decryption of the data is a protocol layer function. Notice that changes in the operating parameters of the physical layer are identified only after decryption and processing by the protocol layer. Although this particular interdependency does not generally cause a problem in a purely hardware implementation, it may cause a problem when all or portions of the protocol layer are implemented in software.

Certain computer systems, especially portable notebook computers, may be equipped with wireless modems. One trend in modem technology involves the use of software modems that implement some of the real-time functions of traditional hardware modems using software routines. Because the hardware complexity of a software modem is less than a hardware counterpart, it is generally less expensive as well as more flexible. For example, the protocol layer decryption and processing may be implemented partially or entirely with software.

Software systems, such as PC systems, run interface control software in operating systems environments as software drivers. These drivers are responsible for communicating to the hardware devices and operate at a privileged level in the operating system. Other software applications are precluded from affecting the drivers. However, because drivers are not protected from other drivers, a variety of problems can occur that might affect the operation of a driver, such as by corrupting its operation. These effects may be caused accidentally, or may be caused by purposeful hacking. A corrupted (or co-opted) driver might cause additional problems outside the computer, such as causing a phone line or wireless channel to be used, operating an external peripheral, or deleting important data.

Because the operating parameters of the physical layer, which control the operation of the transmitter of the mobile station, are controlled by the protocol layer using software, it may be possible for a computer program or virus to take control of the mobile station and cause it to accidentally or purposefully transmit outside of its assigned time slot. A wireless communications network, such as a cellular network, relies on a shared infrastructure. A mobile station must adhere to the ‘rules of the road’ or it may cause interference on the network.

If certain functions of the mobile station are controlled in software, a programmer may determine how the GSM control frames are decoded and how the transmitter module is triggered. A virus may then be written and spread over the network to infiltrate the software-based mobile stations. Then, on a particular time and date, the virus could take direct control of the mobile station and transmit continuously or intermittently and inundate the base stations and other mobile units with random frequencies and full power. Such a virus design could enable and disable at random times to avoid detection, robbing the air-time supplier of some or all of his available bandwidth and may even cause a complete shutdown of the network. Such an attack may take only a few affected devices (i.e., as few as one) per cell to disable the cell completely.

The security problems associated with mobile stations operating in a shared infrastructure may be segregated into three levels of severity: tamper-proof, non-tamperproof, and class break. First, a hardware/firmware implementation (such as a cell-phone) is the hardest with which to tamper, because each device must be acquired individually and modified (i.e., tamper-proof). On the other hand, a software-based solution is easier to tamper with, as a hacker can concentrate on a software-only debugger environment (i.e., non-tamper-proof). Finally, a system with the ability to be tampered with that is similar on all systems and allows the tampering to be distributed to a large number of systems of the same type is susceptible to a ‘class-break.’

A software wireless modem is susceptible not only to a class-break, but also it is among those devices whose code may be accessed from the same layer as IP (internet protocol) or another portable code access mechanism. Many software wireless modems may be integrated into computers coupled to networks or the Internet. Such an arrangement increases the susceptibility of the software to being tampered with and controlled.

Communication devices implementing other communications protocols using software may also be susceptible to some of the problems identified above, but to differing degrees and levels of consequence. For example, software drivers for communication devices using copper subscriber lines, such voice band modems (V.90), asymmetric digital subscriber line (DSL) modems, home phone line networks (HomePNA), etc., may be attacked, resulting in the subscriber line being disabled or improperly used. For example, a group of infected software modems may be used in a denial of service attack to continuously place calls to a predetermined number and overwhelm the destination. The software modem could also be used to prevent outgoing or incoming calls on the subscriber line or disrupt HomePNA traffic. Other wireless communication devices implemented in software, such as wireless network devices, could also be commandeered to disrupt traffic on the wireless network.

The present invention is directed to overcoming, or at least reducing the effects of, one or more of the problems set forth above.

### SUMMARY OF THE INVENTION

One aspect of the present invention is seen in a computer system including a peripheral device and a processor complex coupled to the peripheral device. The processor complex is adapted to load a secure driver including program instructions for interfacing with the peripheral device. The peripheral device may be a communications device, such as a software modem.

Another aspect of the present invention is seen in a method for protecting a software driver. The method includes storing a secure driver in a computer system. The secure driver includes program instructions for interfacing with a peripheral device. The method further includes loading the secure driver and interfacing with the peripheral device using the secure driver. The peripheral device may be a communications device, such as a software modem.

### BRIEF DESCRIPTION OF THE DRAWINGS

The invention may be understood by reference to the following description taken in conjunction with the accompanying drawings, in which like reference numerals identify like elements, and in which:

FIG. 1 is a simplified block diagram of a communications system in accordance with one illustrative embodiment of the present invention;

FIG. 2 is a simplified block diagram of an exemplary computer that embodies a user station in the communications system of FIG. 1; and

FIG. 3 is a simplified flow diagram of a method for protecting a software driver in accordance with another embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

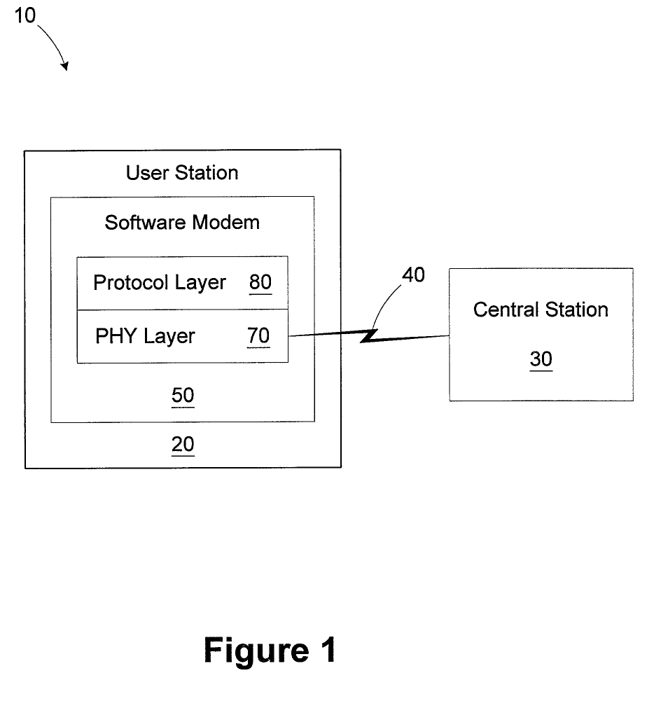

Referring to FIG. 1, a block diagram of a communications system 10 is provided. The communications system 10 includes a user station 20 in communication with a central station 30 over a communication channel 40. In the illustrated embodiment, the user station 20 is a mobile computing device using a software modem 50 to communicate in accordance with a wireless communication protocol, such as GSM. The central station 30 may be a shared base station capable of serving a plurality of subscribers. Although the invention is described as it may be implemented in a wireless environment, its application is not so limited. The teachings herein may be applied to other communication environments using software implemented communication protocols (e.g., V.90, ADSL, HomePNA, Wireless LAN, etc.). Moreover, the teachings may also be applied to providing a secure driver for any peripheral device.

The user station 20 may comprise a variety of computing devices, such as a desktop computer, a notebook computer, a personal data assistant (PDA), etc. For purposes of illustration, the user station 20 is described as it may be implemented using a notebook computer. The software modem 50 may be installed as an internal resource. As will be appreciated by those of ordinary skill in the art, the software modem 50 includes a physical layer (PHY) 70 implemented in hardware and a protocol layer 80 implemented in software. For purposes of illustration, the functions of the software modem 50 are described as they might be implemented for a GSM communication protocol, although other protocols may be used.

The PHY layer 70 converts digital transmit signals into an analog transmit waveform and converts an incoming analog received waveform into digital received signals. For transmit signals, the output of the protocol layer 80 is the transmit “on-air” information modulated about a zero Hz carrier (i.e., a carrierless signal). The PHY layer 70 mixes (i.e., mixing may also be referred to as upconverting) the carrierless transmit signal generated by the protocol layer 80 in accordance with assigned time slot, frequency, and power level assignments communicated to the user station 20 by the central station 30 to generate the actual analog waveform transmitted by the PHY layer 70.

The central station 30 also communicates time slot and frequency assignments to the user station 20 for incoming data. The incoming analog receive waveform is sampled and downconverted based on the assigned time slot and frequency parameters to recreate a carrierless (i.e., modulated about zero Hz) receive waveform. The protocol layer 80 receives the carrierless receive waveform from the PHY layer 70 and performs baseband processing, decryption, and decoding to regenerate the received data.

Collectively, the time slot, frequency, and power level (i.e., for transmit data only) assignments are referred to as control codes. The particular algorithms used for implementing the software modem 50 are described by the particular industry standards (e.g., GSM standards) and are well known to those of ordinary skill in the art, so for clarity and ease of illustration they are not detailed herein.

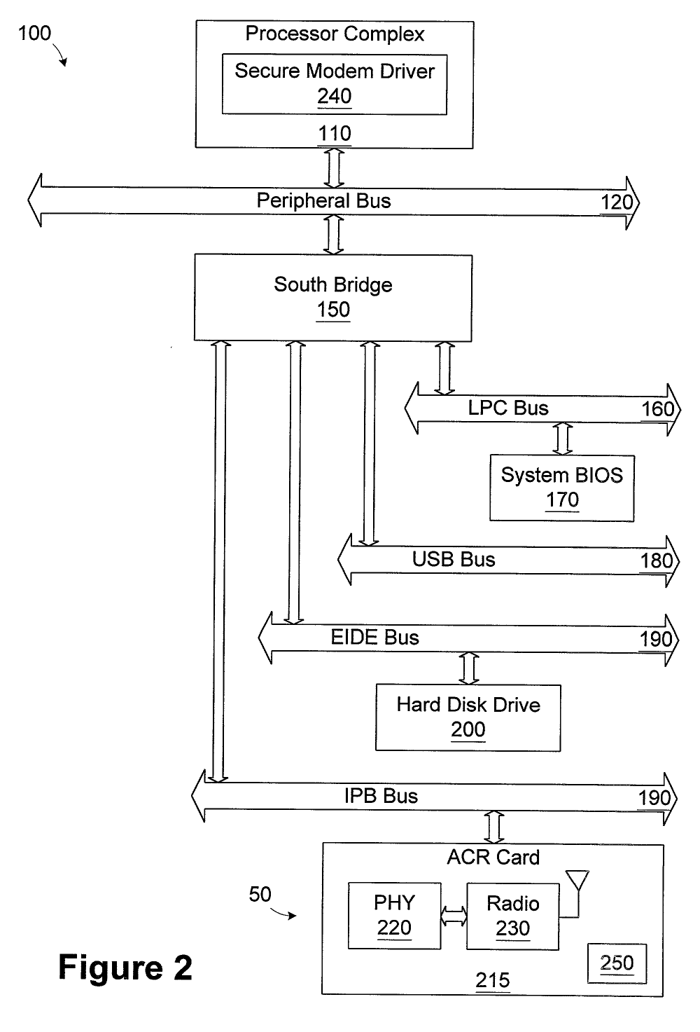

Turning now to FIG. 2, a block diagram of the user station 20 embodied in a computer 100 is provided. The computer 100 includes a processor complex 110. For clarity and ease of understanding not all of the elements making up the processor complex 110 are described in detail. Such details are well known to those of ordinary skill in the art, and may vary based on the particular computer vendor and microprocessor type. Typically, the processor complex 110 includes a microprocessor, cache memories, system memory, a system bus, a graphics controller, and other devices, depending on the specific implementation.

The processor complex 110 is coupled to a peripheral bus 120, such as a peripheral component interface (PCI) bus. Typically a bridge unit (i.e., north bridge) in the processor complex 110 couples the system bus to the peripheral bus 120. A south bridge 150 is coupled to the peripheral bus 120. The south bridge 150 interfaces with a low pin count (LPC) bus 160 that hosts a system basic input output system (BIOS) memory 170, a universal serial bus (USB) 180 adapted to interface with a variety of peripherals (e.g., keyboard, mouse, printer, scanner, scanner) (not shown), an enhanced integrated drive electronics (EIDE) bus 190 for interfacing with a hard disk drive 200 and a CD-ROM drive (not shown), and an integrated packet bus (IPB) 210.

The IPB bus 210 hosts the hardware portion of the software modem 50. In the illustrated embodiment, the software modem 50 is hosted on an advanced communications riser (ACR) card 215. Specifications for the ACR card 215 and the IPB bus 210 are available from the ACR Special Interest Group (ACRSIG.ORG). The software modem 50 includes a PHY hardware unit 220 and a radio 230. In the illustrated embodiment, the radio 230 is adapted to transmit and receive GSM signals. Collectively, the PHY hardware unit 220 and the radio 230 form the PHY layer 70 (see FIG. 1).

The processor complex 110 executes program instructions encoded in a secure modem driver 240. Collectively, the processor complex 110 and the secure modem driver 240 implement the functions of the protocol layer 80 (see FIG. 1). To prevent accidental program corruption or intentional hacking, the secure modem driver 240 is loaded from a secure location during the initialization of the computer 100. Hence, if a virus infects the secure modem driver 240, it will be effectively be eliminated the next time the computer is initialized and the secure modem driver 240 is re-loaded. There are numerous possibilities for providing a secure modem driver 240. The code for the secure modem driver 240 may be protected using hardware security, software security, or a combination of both hardware and software security.

A first example illustrates one embodiment of how a software security solution may be implemented. A variety of file security techniques are known in the art. An exemplary technique involves the use of public and private keys and hashes to create digital signatures. In public key cryptography systems, each user has two complementary keys, a publicly revealed key and a private key. Each key unlocks the code that the other key locks. Knowing the public key does not help in the deduction of the corresponding private key. The public key can be published and widely disseminated. In the context of this application, the secure modem driver 240 may be digitally signed using the private key of the modem or computer system vendor. A public key for the vendor may be stored by the computer 100 (e.g., in the system BIOS memory 170, on the hard disk drive 200, or in a storage device on the ACR riser card 215) and used to authenticate the secure modem driver 240 prior to enabling the modem 50. The vendor's public key is only useful to decrypt data that was encrypted with the vendor's corresponding private key. If the secure modem driver 240 has been altered, for example, by a virus, the authentication will fail.

A hardware technique for protecting the secure modem driver 240 includes storing the secure modem driver 240 in a protected program storage device. For example, the secure modem driver 240 may be stored in the system BIOS memory 170 (e.g., using non-volatile flash memory) and loaded into system memory during the initialization of the computer 10. In some computer systems, updates to the system BIOS memory 170 (e.g., flash memory) may only be performed using an authenticated update file. Hence, only an update file digitally signed by the vendor may be used to update the system BIOS 170. Other systems use password protection for securing the system BIOS 170. Because the secure modem driver 240 is stored in the protected system BIOS 170, it is not susceptible to tampering. Another hardware technique may involve storing the secure modem driver 240 in a non-volatile storage device 250 on the ACR card 215. The storage device 250 may be protected using a tamper-proof enclosure and may require an authenticated file or password for updating. For example, an authentication key may be provided with a software update for the secure modem driver 240. Alternatively, the authentication key may be provided by the central station 30 over the communications channel 40. In still another embodiment, a user could send the software update to a service provider over an internet connection. If the software update is verified, the service provider may provide the authentication key over the internet connection. This verification could also be practiced over the communications channel.

Even if a particular hardware protection scheme is compromised by physical tampering, a class-break fault is prevented. Other mobile devices, such as cellular phones, implemented entirely in hardware, may be susceptible to being compromised through individual physical tampering, but the associated cost and limited tampered unit density of such an attack make it unlikely to have substantial consequences.

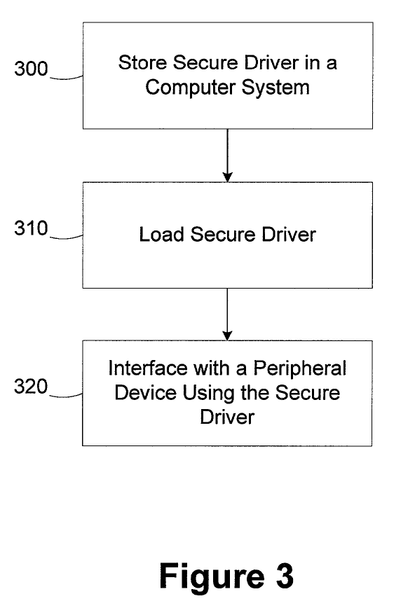

Turning now to FIG. 3, a flow diagram of a method for protecting a software driver is provided. In block 300, a secure driver is stored in a computer system. Storing the secure driver may include digitally signing the secure driver or storing the secure driver in a secure program storage device. In block 310, the secure driver is loaded by the computer system. For example, the computer system may load the secure driver during the initialization or boot process. In block 320, the secure driver is used to interface with a peripheral device. The peripheral device may include a software modem, as illustrated above, or any peripheral device for which a secure driver may be desirable for preventing unintentional or malicious tampering that could deleteriously affect the operation of the computer system or peripheral device.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A communications system, comprising:
physical layer hardware adapted to communicate data over a communications channel, the physical layer being adapted to demodulate an incoming analog signal to generate a digital receive signal and modulate a digital transmit signal to generate an analog transmit signal; and
a processing unit adapted to load a secure driver for interfacing with the physical layer hardware, the secure driver including program instructions for implementing a protocol layer to decode the digital receive signal and encode the digital transmit signal.

2. The system of claim 1, wherein the secure driver comprises a digitally signed file.

3. The system of claim 1, wherein the communications system includes a secure program storage device adapted to store the secure modem driver.

4. The system of claim 3, wherein the secure program storage device comprises a flash memory.

5. The system of claim 3, wherein the processing unit comprises a computer.

6. The system of claim 5, wherein the computer includes:
a processor complex adapted to execute the program instructions in the secure driver;
a bus coupled to the processor complex; and
an expansion card coupled to the bus, the expansion card including the physical layer hardware.

7. The system of claim 6, wherein secure program storage device is located on the expansion card.

8. The system of claim 6, wherein secure program storage device is located in the computer.

9. The system of claim 6, wherein the computer includes a system basic input output system (BIOS) memory adapted to store the secure driver.

10. The system of claim 2, wherein the communications system includes a program storage device adapted to store a public key for authenticating the digitally signed file.

11. The system of claim 2, wherein the processing unit comprises a computer having a system basic input output system (BIOS) memory adapted to store a public key for authenticating the digitally signed file.

12. The system of claim 3, wherein the secure program storage device is secured by an authentication key.

13. The system of claim 12, wherein the physical layer hardware is adapted to receive the authentication key over the communications channel.

14. The system of claim 3, wherein the secure program storage device is secured by a password.

15. A computer system, comprising:
a processor complex adapted to adapted to load a secure driver including program instructions for implementing a communications protocol;
a bus coupled to the processor complex; and
an expansion card coupled to the bus, the expansion card including physical layer hardware adapted to communicate data over a communications channel, the physical layer being adapted to demodulate an incoming analog signal to generate a digital receive signal and modulate a digital transmit signal to generate an analog transmit signal, wherein the secure driver interfaces with the physical layer hardware to decode the digital receive signal and encode the digital transmit signal.

16. The computer system of claim 15, wherein the secure driver comprises a digitally signed file.

17. The computer system of claim 15, further comprising a secure program storage device adapted to store the secure modem driver.

18. The computer system of claim 17, wherein the secure program storage device comprises a flash memory.

19. The computer system of claim 17, wherein secure program storage device is located on the expansion card.

20. The computer system of claim 15, further comprising a computer basic input output system (BIOS) memory adapted to store the secure driver.

21. The computer system of claim 16, further comprising a program storage device adapted to store a public key for authenticating the digitally signed file.

22. The computer system of claim 16, further comprising a system basic input output system (BIOS) memory adapted to store a public key for authenticating the digitally signed file.

23. The computer system of claim 17, wherein the secure program storage device is secured by an authentication key.

24. The computer system of claim 23, wherein the physical layer hardware is adapted to receive the authentication key over the communications channel.

25. The computer system of claim 17, wherein the secure program storage device is secured by a password.

26. A computer system, comprising:
a peripheral device; and
a processor complex coupled to the peripheral device and adapted to load a secure driver including program instructions for interfacing with the peripheral device.

27. The computer system of claim 26, wherein the secure driver comprises a digitally signed file.

28. The computer system of claim 26, further comprising a secure program storage device adapted to store the secure modem driver.

29. The computer system of claim 28, wherein the secure program storage device comprises a flash memory.

30. The computer system of claim 28, wherein secure program storage device is located on the peripheral device.

31. The computer system of claim 26, further comprising a computer basic input output system (BIOS) memory adapted to store the secure driver.

32. The computer system of claim 27, further comprising a program storage device adapted to store a public key for authenticating the digitally signed file.

33. The computer system of claim 27, further comprising a system basic input output system (BIOS) memory adapted to store a public key for authenticating the digitally signed file.

34. The computer system of claim 28, wherein the secure program storage device is secured by an authentication key.

35. The computer system of claim 34, wherein the physical layer hardware is adapted to receive the authentication key over the communications channel.

36. The computer system of claim 28, wherein the secure program storage device is secured by a password.

37. A method for protecting a software driver, comprising:
storing a secure driver in a computer system, the secure driver including program instructions for interfacing with a peripheral device;
loading the secure driver; and
interfacing with the peripheral device using the secure driver.

38. The method of claim 37, wherein storing the secure driver comprises storing a digitally signed file.

39. The method of claim 37, wherein storing the secure driver comprises storing the secure driver in a secure program storage device.

40. The method of claim 39, wherein storing the secure driver in the secure program storage device comprises storing the secure driver in a flash memory.

41. The method of claim 37, wherein storing the secure driver comprises storing the secure driver in a secure program storage device located on the peripheral device.

42. The method of claim 37, wherein storing the secure driver comprises storing the secure driver in a computer basic input output system (BIOS) memory in the computer system.

43. The method of claim 38, further comprising storing a public key for authenticating the digitally signed file in the computer system.

44. The method of claim 43, wherein storing the public key for authenticating the digitally signed file comprises storing the public key in a system basic input output system (BIOS) memory in the computer system.

45. The method of claim 37, wherein loading the secure driver comprises loading the secure driver during an initialization of the computer system.

46. The method of claim 39, wherein storing the secure driver in the secure program storage device comprises securing the secure program storage device with an authentication key.

47. The computer system of claim 46, further comprising receiving the authentication key over the communications channel.

48. The computer system of claim 39, wherein storing the secure driver in the secure program storage device comprises securing the secure program storage device with a password.

49. A method for providing a secure driver, comprising:
storing a secure driver, the secure driver including program instructions for implementing a communication protocol;
loading the secure driver; and
communicating data over a communications channel based on the program instructions in the secure driver.

50. The method of claim 49, wherein communicating data over the communications channel includes:
demodulating an incoming analog signal to generate a digital receive signal;
modulating a digital transmit signal to generate an analog transmit signal;
decoding the digital receive signal based on the program instructions in the secure driver; and
encoding the digital transmit signal based on the program instructions in the secure driver.

51. The method of claim 49, wherein storing the secure driver comprises storing a digitally signed file.

52. The method of claim 49, wherein storing the secure driver comprises storing the secure driver in a secure program storage device.

53. The method of claim 52, wherein storing the secure driver in the secure program storage device comprises storing the secure driver in a flash memory.

54. The method of claim 52, wherein storing the secure driver comprises storing the secure driver in a secure program storage device located in a computer.

55. The method of claim 49, wherein storing the secure driver comprises storing the secure driver in a secure program storage device located in an expansion card.

56. The method of claim 49, wherein storing the secure driver comprises storing the secure driver in a computer basic input output system (BIOS) memory in a computer system.

57. The method of claim 49, further comprising storing a public key for authenticating the digitally signed file.

58. The method of claim 57, wherein storing the public key for authenticating the digitally signed file comprises storing the public key in a system basic input output system (BIOS) memory in a computer system.

59. The method of claim 52, wherein storing the secure driver in the secure program storage device comprises securing the secure program storage device with an authentication key.

60. The method of claim 59, further comprising receiving the authentication key over the communications channel.

61. The method of claim 52, wherein storing the secure driver in the secure program storage device comprises securing the secure program storage device with a password.
